(19) United States
(12) Patent Application Publication
(10) Pub. No.: US 2016/0122640 A1
(43) Pub. Date: May 5, 2016

(54) Silicon Precursors for Sunthesizing Multi-Elemental Inorganic Silicon-Containing Materials and Methods of Synthesizing Same

(71) Applicant: Nitto Denko Corporation, Osaka (JP)

(72) Inventors: Rajesh Mukherjee, Irvine, CA (US); Stephen J. Grunzinger, Oceanside, CA (US)

(21) Appl. No.: 14/993,962

(22) Filed: Jan. 12, 2016

Related U.S. Application Data
(63) Continuation of application No. 13/161,295, filed on Jun. 15, 2011.
(60) Provisional application No. 61/357,748, filed on Jun. 23, 2010.

(51) Int. Cl. C09K 11/77

(52) U.S. Cl. CPC C09K 11/7774; C09K 11/7734

(57) ABSTRACT

A method for making silicon materials includes providing a multi-elemental water-soluble precursor solution comprising at least one silicon precursor and applying a heat source to the silicon precursor to form a multi-elemental silicon material. A composition, light emitting element and light emitting device including the silicon materials made in accordance with the method are described.

### CROSS-REFERENCE TO RELATED APPLICATIONS

This application claims the benefit of U.S. Provisional Application No. 61/357,748, filed Jun. 23, 2010, under 35 USC 119(e), and the disclosure of which is herein incorporated by reference in its entirety.

### BACKGROUND OF THE INVENTION

1. Field of the Invention

This disclosure relates to water-soluble silicon precursors useful in the manufacture of multi-elemental inorganic compounds of silicon and also relates to methods of manufacturing the same.

2. Description of the Related Art

Silicon-based materials such as silicon oxide materials can be produced via several different wet chemistries as well as via solid state and combustion routes. Some current goals in these processes include a reduction of organic contamination and defective crystalline structure and an improvement of purity while gaining stoichiometric control over the final product. Improving any of these may improve the properties of silicon-containing materials desirable for various applications, e.g., the properties when used as phosphor hosts or scintillators.

Non-equilibrium thermo-chemical flow-based synthesis methods such as thermal plasma-based aerosol or gas phase synthesis, flame spray pyrolysis, spray pyrolysis, and other processes of a similar nature are promising because they may reduce contaminants and improve control over particle shapes and sizes. These processes are also very suitable for continuous production compared to the batch processing nature of wet synthesis. However, none of the current non-equilibrium thermo-chemical flow-based synthesis methods are practically capable of producing any multi-elemental silicon-containing materials with stoichiometric control since the precursors in use are introduced most commonly in the vapor phase (also sometimes using solid phase), making control of stoichiometric ratios of silicon elements and other elements for complex multi-elemental compounds extremely difficult if not impossible. Moreover, these precursors are often highly hazardous (like silane). Solution precursors are also used in current non-equilibrium thermo-chemical flow-based synthesis methods, but we are not aware of their use in producing multi-elemental silicon-containing materials by these methods.

Further, in order to obtain functional silicon-containing materials, hybridization of silicon oxide materials with organic molecules may be conducted. However, the hybridization has been carried out by a solid-phase reaction because the silicon oxide materials cannot dissolve in any solvents due to their huge three- and/or two-dimensional molecular structures. Responsive to this problem, some have synthesized water-soluble silicon oxide materials by sol-gel reaction of an alkyloxysilane in acidic or basic solutions as shown in Kaneko et al., J. Mater. Res., 20(8):2199-2204 (2005). However, the use of strongly acidic or basic solutions can have adverse effects upon the synthesizing apparatus, and also the resultant silicon-containing material is a hybridized organic material which is dissimilar to inorganic multi-elemental silicon materials, and further, the processes described refer only to a production of bi-elemental oxide silicon-containing materials. In Suzuki et al., J. Ceram. Soc. of Japan 117(3):330-334 (2009), inorganic multi-elemental silicon-containing materials are obtained using a specifically-prepared water-soluble silicon precursor. However, the solution not only uses an acidic solution but also is subjected to complex chelating and polyestification prior to heat treatment, which is similar to sol-gel methods.

Thus, there is a need for better precursors to create multi-elemental silicon-containing materials. Hence, identification and use of a soluble silicon precursor system which stably dissolves in common solvents and more particularly in water would clearly be extremely beneficial for the manufacture of complex multi-elemental silicon-containing materials. There is also a need for water-soluble silicon precursors to enable better stoichiometric control for constant material synthesis across the entire duration of the thermo chemical manufacturing run. In addition, many of the water-stable silicon precursors are composed of alkali salts (Na, Li, etc.) of silanols, which may make them unsuitable as precursors for any product that is not composed of that alkali atom.

### SUMMARY OF THE INVENTION

As illustrated in FIG. 1, some embodiments provide a method of making silicon materials comprising (i) selecting soluble precursors comprising at least one silicon containing precursor, said precursors being soluble in a solvent by themselves; forming a precursor solution by dissolving at least one silicon containing precursor in a solvent; and (ii) applying heat to the precursor solution to form an inorganic multi-elemental silicon material.

In some embodiments, the soluble precursors comprise additional precursors for other elements desired in the silicon material end-product.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not necessarily to scale.

FIG. 1 illustrates an exemplary embodiment of a method of preparing silicon materials disclosed herein.

FIG. 2 shows a schematic of some embodiments of the present method.

FIG. 3 is a chart of XRD analysis of the material obtained in Example 1.

FIG. 4 is a chart of XRD analysis of the material obtained in Example 2.

FIG. 5 is a chart of XRD analysis of the material obtained in Example 3.

### DETAILED DESCRIPTION

In some embodiments, the present invention provides a method for making multi-elemental silicon materials which include bi-elemental non-oxide silicon materials and multi-elemental silicon materials, said method comprising selecting soluble precursors comprising at least one silicon containing precursor, said precursors being soluble in a solvent by themselves; forming a precursor solution by dissolving at least one silicon containing precursor in a solvent; and applying heat to the precursor solution to form an inorganic multi-elemental silicon material.

The term “bi-elemental non-oxide” refers to a compound containing 2 different atomic elements, wherein the 2 different elements do not include oxygen.

The term “multi-elemental” refers to least 3 different atomic elements.

The term “water-soluble” or “soluble in water” refers to the amount of water that is required to dissolve a given amount of solute, e.g., precursor. In one embodiment, the term water-soluble includes very soluble, freely soluble and soluble materials. The term “very soluble” refers to a level of solubility of at least one gram of solute in less than 1 gram of solvent. The term “freely soluble” refers to a level of solubility of at least one gram of solute in 1 gram to 10 grams of solvent. The term “soluble” refers to a level of solubility of at least one gram of solute in about 10 to about 30 grams of solvent. See United Stated Pharmacoepia, USP26, NF21 (2003). Solubility or dispersibility is determined at ambient conditions (e.g., a temperature of about 25° C. and at atmospheric pressure).

The term “soluble in water by themselves” or “soluble in water by itself” refers to a compound that is soluble in water without chemical modification or addition to enhance its solubility.

In some embodiments, the precursor solution includes at least one silicon precursor and a solvent. In one embodiment, the silicon precursor is an organosilane. In other embodiments, the organosilane is not limited to but may be at least one selected from 3-aminopropylsilane triol, 3-aminopropyltrimethoxysilane, 3-aminopropylethoxysilane, 3-aminopropylisopropoxysilane, tetramethylammonium silicate, water-soluble-POSS including PEG-POSS and OctaAmmonium POSS, carboxyethylsilanetriol sodium salt, sodium methylsiliconate, sodium metasilicate, 3-(trihydroxysilyl)-1-propanesulfonic acid, sodium 3-(trihydroxysilyl)-1-propanesulfonate, and sodium 3-trihydroxysilylpropylmethylphosphonate. In some embodiments, the silicon precursor consists essentially of the organosilane.

In some embodiments, the precursor solution includes optional precursors for other elements desired in the final product. In some embodiments, the optional precursors include atomic elements not present in the silicon precursor but are present in the desired end product. In a non-limiting example, where the desired end product is cerium and manganese co-doped Lu₂CaAl₄SiO₁₂, compounds Lu(NO₃)₃.xH₂O, Ca(NO₃)₃.4H₂O, Al(NO₃)₃.6H₂O, Mn(NO₃)₃.6H₂O(Alfa Aeser, 99.98%), and Ce(NO₃)₃.6H₂O, can be present in addition to 3-aminopropylsilanetriol, for example. Further, depending on the final product, Mg(NO)₃.6H₂O, Eu(NO₃)₃.5H₂O, Y(NO₃)₃.6H₂O, Gd(NO₃)₃.6H₂O, and other metal nitrate hydrates can be used. La, Pr, Nd, Sm, Tb, Dy, Ho, etc. are available in the form of nitrate hydrates. Further, any suitable soluble form of these elements can be used, including, but not limited to, acetate hydrates, acetylacetonate hydrates, bromide hydrates, carbonate hydrates, chloride hexahydrates, chloride hydrates, hydroxide hydrates, oxalate hydrates, sulfate octahydrates, etc. The precursor solvent may be any solvent, including, but not limited to water, methanol, ethanol, acetone, isopropanol, dichloromethane, benzene, toluene, ethyl acetate, pentane, hexanes, ethyl ether, dimethylformamide, dimethylsulfoxide, etc. In some embodiments the solvent is water. In one embodiment, the precursor solution is single-phase. In another embodiment, the term water soluble silicon precursor does not include suspensions or emulsions comprising the precursor material and water.

In one embodiment the precursor solution is between about pH 5.0 to about pH 9.0. In another embodiment the precursor solution is between about pH 6.0 to about pH 8.0. In another embodiment, the precursor solution is between about pH 6.5 to about pH 7.5.

In another embodiment, the precursor solution includes a stabilizing compound. Stabilizing compounds are useful where the compounds become slightly basic or acidic. In some embodiments, the stabilizing compound can be selected from slightly basic compounds. In some embodiments the stabilizing compound is selected from ammonium compounds. In some embodiments the stabilizing compound is selected from but not limited to urea, ammonium hydroxide, and carbohydrazide.

In another embodiment, the precursor solution is substantially halide free. In one embodiment, the suitable precursor solution has only trace amounts of halides.

In some embodiments, a heat source, is applied to the silicon containing precursor solution to form the inorganic silicon material. In some embodiments the heat source is a flowing heat source. In some embodiments, the heat source is a static heat source.

The heat source provides sufficient thermal energy to vaporize the solvent. The particular sufficient thermal energy is dependent upon the carrier solvent selected. For example, the thermal energy provided is sufficient to raise the precursor solution temperature to above its boiling point. In some embodiments the suitable flowing heat source is selected from a plasma, a flame spray, a hot-wall reactor or a spray pyrolysis system. A flowing heat source is any source of thermal energy applying heat to the precursor solution, where the fluid (in most cases an ambient gas which can be air or a reactive gas or an inert gas or a gas mixture) containing a dispersion of precursor solution, e.g., an aerosol, has substantial bulk velocity, for instance more than 1 m/s. In one embodiment, the plasma is a thermal plasma. In some embodiments, the plasma is a RF inductively coupled thermal plasma. The temperature of the flowing heat source may vary. For example, the temperature in the reaction field may range from at least about 500° C., about 800° C. or about 1000° C., to about 10,000° C. or about 20,000° C. In some embodiments, at least a portion of the reaction field has a temperature of at least about 500° C.

In some embodiments, the heat source is a static heat source. In some embodiments, the static heat source is selected from a box furnace and a muffle furnace. A static heat source is any source of thermal energy applying heat to the precursor solution, where the working fluid (which is a medium for transmitting heat energy; in most cases an ambient gas which can be air or a reactive gas or an inert gas or a gas mixture) containing a dispersion of precursor solution, e.g., an aerosol, has substantially zero bulk velocity; i.e. it is static. Temperature ranges for such heat treatment may range from about 1000 to 1000° C. or about 250° C. to about 500° C.

In some embodiments, the precursor solution comprises or consists essentially of silicon, hydrogen, nitrogen, carbon and oxygen atoms. In some embodiments, the precursor solution comprises of silicon, hydrogen, nitrogen, carbon and oxygen atoms and any other elements included in the final product. In some embodiments, the precursor solution comprises of water-soluble compounds whose amounts are controlled at stoichiometric ratios for the final product in addition to a pH adjusting agent or a pH neutralizer for neutralizing the pH when metal nitrate hydrates, for example, are used as the multi-elemental compounds.

In some embodiments, a method for making a multi-elemental silicon material comprises: (i) providing an aqueous solution which uses water as a solvent and is stoichiometrically controlled for multi-elements contained in a target multi-elemental silicon material, said aqueous solution is constituted by a water-soluble precursor including at least one silicon precursor compound that is soluble in water by itself without chemical changes other than dissolving in water, and (ii) heating the aqueous solution to remove the solvent without forming a gel and to remove organic matter from a remaining solute, thereby forming the target multi-element silicon material. In some embodiments, the method can be performed without going through sol-gel processes, polymerization, or hybridization. The compound may be dissolved nearly or substantially instantly or without other reactions or treatment upon adding the compound to a solvent. In some embodiments, the viscosity of the precursor solution does not substantially change while dissolving the compounds or with time, and the precursor solution remains in the form of solution, not gel. In the aqueous solution, nearly or substantially no reaction may take place and the stoichiometric ratios of the final product can be fixed in the precursor solution. In view of the above, stoichiometric control can effectively be performed even when droplets are formed (each micro- or nano-droplet can have identical components).

In some embodiments, heating the aqueous solution removes the solvent and causes conversion reactions to produce a ceramic material. Further heating can decompose organic material, especially under nitrogen or oxygen conditions. In some embodiments, annealing may be performed to produce the final desired phase.

In some embodiments, the invention includes a composition prepared by any of the methods described herein. In some embodiments, the invention includes a particle composition prepared by any of the methods described herein. In some embodiments, the invention includes a nanoparticle composition prepared by any of the methods described herein. In some embodiments, the invention includes a film prepared by any of the methods described herein. In some embodiments, the invention includes a porous aggregate composition prepared by any of the methods described herein. In some embodiments, the invention includes a doped silicate prepared by any of the methods described herein. In some embodiments, the doped silicate has a garnet structure. In some embodiments, the silicate garnet is cerium-doped. In some embodiments, the silicate garnet is doped with europium. In some embodiments, the silicate garnet is co-doped with cerium and manganese.

The precursor solution described above may be suspended in a carrier gas to provide an aerosol. The aerosol may include any suspension of a plurality of droplets of the precursor solution in a gas. The aerosol may be provided prior to the application of heat thereto. The size of the individual droplets may vary. In some embodiments, about 95% of the plurality of droplets by number has a diameter in the range of about 20 nm to 200 μm, about 100 nm to about 120 μm, or about 2 μm to about 120 μm. The carrier gas may be any gas suitable for suspending the precursor solution. In some embodiments the carrier gas can be an inert or otherwise non-reactive gas such as helium, neon, argon, krypton, xenon, nitrogen or a combination thereof, wherein the carrier gas is non-reactive with the nanoparticle precursors, solvents, or expansive components. In some embodiments, the carrier gas may comprise a reactive gas such as O₂, NH₃, air, H₂, alkanes, alkenes, alkynes, etc., which may participate in the reaction to form the final product composition. In some embodiments, the carrier gas can be a mixture comprising at least one reactive gas and at least one inert gas. In some embodiments, the carrier gas is nitrogen, argon, or hydrogen. In some embodiments, the carrier gas comprises argon.

The aerosol may be provided by suspending the precursor solution in the carrier gas by any means known in the art such as using an atomizer or a nebulizer, or via a simple nozzle. Any kind of atomizer or nebulizer can be used for instance, two-fluid, Collison, ultrasonic, eletrospray, spinning disc, filter expansion aerosol generator, etc. In some embodiments, the aerosol may be formed via two-fluid atomization and discharged directly into the flowing heat source e.g. a plasma. In some embodiments, the aerosol may be formed using a remote nebulizer and then delivered to the flowing heat source e.g. a plasma. Exemplary methodologies of heating processes and aerosol processes are discussed in WO2008112710 A1, which are incorporated by reference herein. In some embodiments, the flow rate of the precursor solution and the carrier gas are independent. Thus, for example, the precursor solution may have a flow rate of from about 0.5 ml/min to about 1000 ml/min, or about 5 ml/min to about 100 ml/min. Similarly, for example, the carrier gas may have a flow rate of about 0.5 slm to about 500 slm, or about 5 slm to about 50 slm.

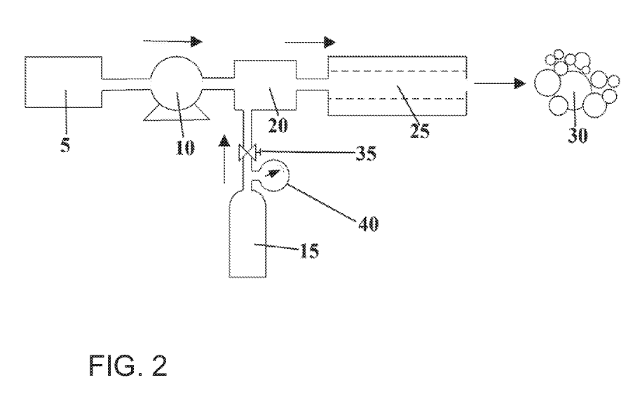

FIG. 2 depicts an embodiment of a device that may be used to provide the aerosol for delivery to a plasma 25 to provide a silicon material 30. A source 5 of the precursor solution may be pumped by an optional fluid pump 10 and suspended in a carrier gas stream 15 in an aerosol delivery apparatus 20, which premixes a carrier gas and the precursor solution, atomizes the precursor solution, or nebulizes the precursor solution to create the appropriate aerosol. In some embodiments, a valve 35 may be used to control the flow of the carrier gas. In some embodiments, controlling the flow of the carrier gas may provide control of the flow ratio of the carrier gas to the precursor solution. A flow meter or pressure gauge 40 may be used to accurately control such flow. Exemplary methodologies of gas phase processes and aerosol processes are discussed in WO2008112710 A1, which are incorporated by reference herein. The apparatus 20 may be an atomizer, such as a two-fluid atomizer, a nebulizer, or any other suitable feature which may provide an aerosol. In some embodiments, the flow rate of the precursor solution and the carrier gas are independent. Thus, for example, the precursor solution may have a flow rate of from about 0.5 ml/min to about 1000 ml/min, or about 5 ml/min to about 100 ml/min. Similarly, for example, the carrier gas may have a flow rate of about 0.5 slm to about 500 slm, or about 5 slm to about 50 slm.

In one embodiment, the aerosol thus provided is passed through a plasma having a reaction zone, such as the plasma 25 of FIG. 2. In one embodiment, the heat is generated in a reaction zone as the aerosol is passed therethrough. Any thermal plasma may be used. A person skilled in the art may choose the appropriate type of plasma device and system setup based on considerations disclosed later herein. The term “plasma” has the ordinary meaning understood by one of ordinary skill in the art. In some embodiments, the plasma comprises a partially ionized gas comprising ions, electrons, atoms, and molecules. In some embodiments, the plasma may be a radio frequency (RF) inductively coupled thermal plasma or a direct current (DC) thermal plasma. Quench gas flow, if any, may be injected at various angles to the plasma torch axis at the exit of the torch. In some embodiments, a quench gas flow can be supplied symmetrically at the exit of the hot reaction zone of the plasma, meaning a point where the flow exits the hot area of the plasma. In some embodiments, the quench gas flow may be applied at any angle between about 0° to about 90° with respect to the axis of the plasma torch. In other words, in some embodiments, the quench gas flow may be applied about transverse to the plasma torch axis (hence transverse to the plasma) or may be applied in approximately a direction opposing the plasma flow, or any direction in between. In some embodiments, a nanoparticle composition from the reaction initiated in the precursor solution by the plasma is obtained without quenching, meaning that no quench gas is applied to flow exiting the hot reaction zone of the plasma. In some embodiments, a film composition from the reaction initiated in the precursor solution by the plasma is obtained on a suitable substrate without quenching, meaning that no quench gas is applied to flow exiting the hot reaction zone of the plasma

The temperature of the plasma may vary. For example, the temperature in the reaction zone may range from at least about 500° C., about 800° C. or about 1000° C., to about 10,000° C. or about 20,000° C. In some embodiments, at least a portion of the reaction field has a temperature of at least about 1000° C.

In one embodiment, once the aerosol has passed through the reaction zone, the inorganic silicon material is collected after the material has exited the reaction zone. In some embodiments, once the aerosol has passed through the plasma, nanoparticles, as the organic multi-elemental silicon material separated from the carrier gas, may be collected from the carrier gas which has exited from the heat source, e.g., the plasma and has heated the droplets. In some embodiments 95% of the nanoparticles by number in the nanoparticle composition have a diameter in the range of about 10 nm to about 10 μm, about 10 nm to about 1 μm, about 10 nm to about 500 nm, or about 10 nm to about 100 nm. In some embodiments, the specific surface area of the nanoparticle composition is in the range of about 5 m²/g to about 200 m²/g, about 5 m²/g to about 100 m²/g, or about 5 m²/g to about 50 m²/g. In some embodiments, the process may produce nanoparticles of the size ranges described above without quenching. In some embodiments, the droplets in the precursor aerosol may completely vaporize depending upon plasma conditions and the mechanism of particle or film formation follows a vapor-phase process. In another embodiment the aerosol droplets may undergo a one-droplet-to-one-particle process depending upon plasma conditions.

Once the nanoparticles are collected from the plasma, in some embodiments they may be further subjected to post processing steps including but not limited to an annealing step. Details of some examples the annealing step can be found in WO2008/112710, WO/2009/105581, and co-pending patent application Ser. No. 12/388,936, filed Feb. 19, 2009, and Ser. No. 12/389,177, filed Feb. 19, 2009, the disclosures of all of which are incorporated by reference herein in their entirety. Other methods are also known in the art, and may be used with the methods described herein. In some embodiments, annealing may occur at any temperature of about 500° C. or higher, such as from about 1000° C. to about 1400° C., about 1100° C. to about 1300° C. or from about 1150° C. to about 1250° C. For example, in some embodiments, nanoparticles may comprise undoped or doped (such as cerium doped) silicate garnets.

In some embodiments, the nanoparticles comprise a garnet. The garnet may have a composition A₃B₅O₁₂, wherein A and B are independently selected. In some embodiments. A can be selected from elements including but not limited to: Y, Gd, La, Lu, Tb, Ca, Sc, Sr; B can be selected from elements including but not limited to: Al, Ga, Si, Ge, Mg and In. In some embodiments, the garnet is doped with at least one element, preferably a rare earth metal. In some embodiments, the rare earth metal is selected from the group including but not limited to Ce, Gd, La, Tb, Pr, Sm and Eu. In some embodiments, the garnet is doped with at least one element, preferably a non-rare earth element. In some embodiments, the rare earth metal is selected from the group including but not limited to Mn and Cr. In some embodiments, the silicate material can be a non-garnet material, e.g., (Sr, Ca, Ba)₂SiO₄:Eu, Ca₃Sc₂Si₃O₁₂:Ce, Ba₃MgSi₂O₈:Eu, CaAlSiN₃:Eu, Ca₂Si₅N₈:Eu, and CaSiAlON:Eu.

In some embodiments, in addition to or in the alternative to the silicates disclosed herein, one or more of any suitable silicates such as those disclosed in 1) HARRY BERMAN, “Constitution and Classification of the Natural Silicates,” American Mineralogist (Journal Mineralogical Society of America), 22, 151 342-408 (1937); and 2) CHARLES. K. SWARTZ, “Classification of the Natural Silicates Part II. Composition of the Natural Silicates,” American Mineralogist (Journal Mineralogical Society of America), 22, 151 1161-1174 (1937) can be used, the disclosure of each of which is herein incorporated by reference in its entirety.

In one embodiment, the precursor solution and the thus-formed multi-elemental silicon material comprises an activating or dopant material at a concentration of between 0.050 mol % to about 10.000 mol %. In another embodiment, the precursor solution comprises a dopant concentration of between 0.125 mol % to about 5.000 mol %. In another embodiment, the precursor solution comprises a dopant concentration of between about 0.125 mol % to about 3.000 mol %. In another embodiment, the precursor solution comprises a dopant concentration of between 1.000 mol % to about 2.750 mol %, including, but not limited to, 0.100, 0.200, 0.500, 1.000, 1.250, 1.500, 1.750 or 2.000 mol %, or any number between any two of the foregoing numbers.

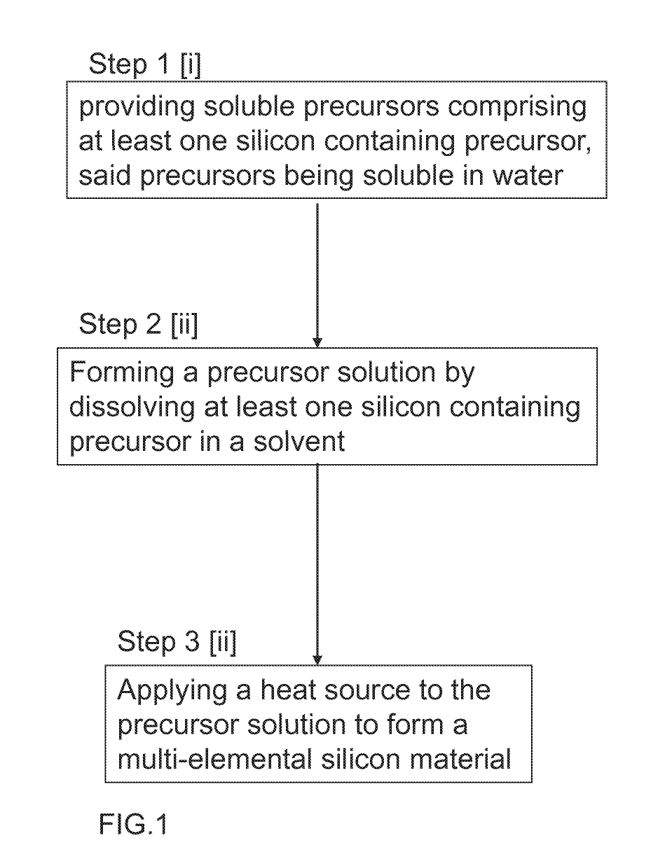

In another embodiment, as illustrated in FIG. 1, a method of obtaining silicon materials is described which comprises the steps of providing a multi-elemental water-soluble precursor solution comprising at least one silicon precursor and applying a heat source to form a multi-elemental silicon material. In one embodiment, the method further comprises at least a carrier solvent. In another embodiment, the method comprises the step of providing an aerosol comprising a plurality of droplets of the precursor solution and a carrier gas. In another embodiment, the method includes the step of passing the aerosol through the heat source. In another embodiment, the method includes adding a stabilizing compound. In another embodiment, the flow-based thermochemical synthesis method includes RF thermal plasma synthesis.

In some embodiments, the nanoparticles have a particle size between 30 nm and about 5 μm. In another embodiment, the particle size is between 30 nm and 1 μm. In still another embodiment, the particle size is between 30 μm and 500 nm. In another embodiment, the particle size may be any size between any two of the foregoing numbers.

In some embodiment, the method includes the steps of heating the multi-elemental silicon material to remove organic components.

The disclosed embodiments include a composition prepared by any of the disclosed methods. In some embodiments, the composition is a cerium doped silicate garnet. Further, the disclosed embodiments include a light-emitting device comprising: (a) a light-emitting diode, and (b) a phosphor comprising any of the disclosed compositions, wherein the phosphor is positioned to receive and convert at least a portion of the light emitted from the light-emitting diode to light of a longer wavelength or a spectrum of longer wavelengths. Additionally, the disclosed embodiments include a light-emitting layer comprising a phosphor comprising any of the disclosed compositions.

In the present disclosure where conditions and/or structures are not specified or are not disclosed in the references incorporated herein by reference, the skilled artisan in the art can readily provide such conditions and/or structures, in view of the present disclosure, as a matter of routine experimentation. Also, in the present disclosure, the numerical numbers applied in specific embodiments can be modified by a range of at least ±50% in other embodiments, and the ranges applied in embodiments may include or exclude the endpoints.

The present invention will be explained in detail with reference to Examples which are not intended to limit the present invention.

### Example 1

### Cerium-Doped Lu₂CaMg₂Si₃O₁₂ Garnet

Based on the stoichiometric ratios for a cerium-doped Lu₂CaMg₂Si₃O₁₂ garnet, the following compounds were used: A solution was prepared using 210.45 g of Lu(NO₃)₃.xH₂O (Metall.cn, 46.8% TREO), 59.60 g of Ca(NO₃)₃.4H₂O (Sigma Aldrich, 99%), 129.49 g Mg(NO₃)₃.6H₂O (Fluka, 99%), 2.17 g of Ce(NO₃)₃.6H₂O (Sigma Aldrich, 99.99%), 411.63 g 3-aminopropylsilanetriol (Gelest, 25% water solution) and 1.3 kg urea (Sigma Aldrich, 98%) in 1000 ml of water.

A) About 10 ml of the solution prepared in Example 1 was combusted in an alumina boat at 500° (in a muffle furnace. The resulting powder was collected, ground and annealed at 1350° C. for about 5 hours in a tube furnace under a 97% N₂/3% H₂ atmosphere. Luminescent material comprising cerium-doped Lu₂CaMg₂Si₃O₁₂ with a garnet structure was thus prepared as verified by comparing X-ray diffraction pattern of the obtained material with a diffraction pattern from a standard garnet (Joint Committee for Powder Diffraction Standards [JCPDS], Card No. 01-072-1853 [corresponding to yttrium aluminum garnet, YAG]).

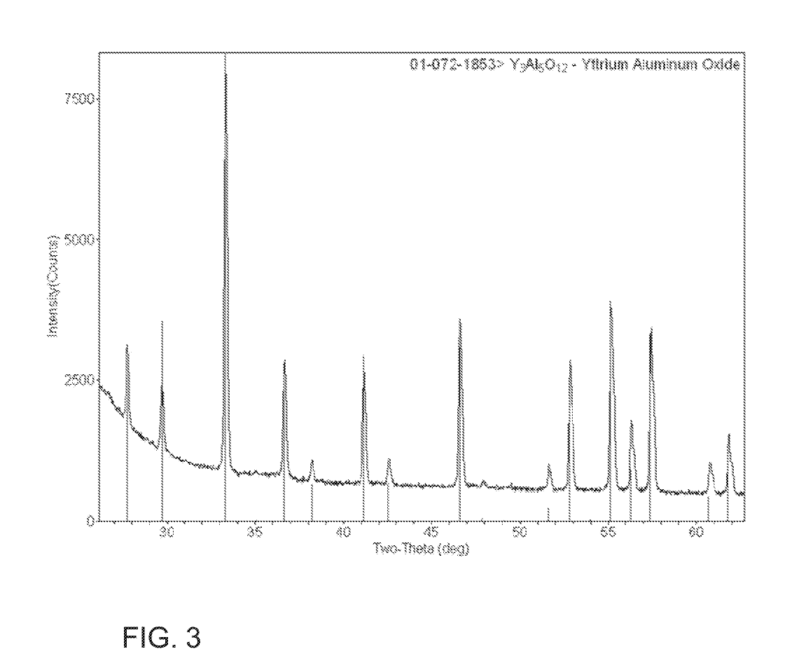

B) About 1000 ml of the solution prepared in Example 1 was delivered as atomized droplets into the hot reaction zone of a RF inductively coupled thermal plasma torch (Tekna Plasma Systems, Inc, Model No. PL-35, Sherbrooke, Quebec, Canada) operated at 20 kW plate power using 10 slm argon atomization gas. The plasma gas flow rates were as follows: central gas=20 slm argon, sheath gas=60 slm argon with 3 slm hydrogen. The solution underwent a combination of one-droplet-to-one-particle and vapor-to-particle conversion while passing through the plasma plume which can have maximum temperature regions over about 10,000 K. The resulting particles were collected on porous ceramic filters. The particles were subsequently annealed at about 1350° C. for about 5 hours in a tube furnace (MTI, Model GSL-1700. California, USA) under a 97% N₂ 3% H₂ atmosphere. Luminescent material comprising cerium-doped Lu₂CaMg₂Si₃O₁₂ with a garnet structure was hence prepared. XRD analysis confirmed that the materials prepared had a garnet structure as shown in FIG. 3 (Joint Committee for Powder Diffraction Standards [JCPDS], Card No. 01-072-1853 [corresponding to yttrium aluminum garnet, YAG]). Further quantitative energy dispersive spectrometry (EDS) analysis in a scanning electron microscope (SEM) confirmed the stoichiometric ratios of the non-oxygen elements as presented in Table 1 below.

TABLE 1
Lu₂CaMg₂Si₃O₁₂
Normalized to Lu atoms

| Mg | Si | Ca | Lu |
|---|---|---|---|
| 2.06 | 2.45 | 0.87 | 2.00 |

### Example 2

### Cerium and Manganese co-doped Lu₂CaAl₄SiO₁₂ Garnet

Based on the stoichiometric ratios for a cerium and manganese co-doped Lu₂CaAl₄SiO₁₂ garnet, the following compounds were used: A solution was prepared using 212.57 g of Lu(NO₃)₃.xH₂O (Metall.cn, 46.8% TREO), 50.06 g of Ca(NO₃)₃.4H₂O (Sigma Aldrich, 99%), 365.25 g Al(NO₃)₃.6H₂O(Sigma Aldrich, >985), 11.48 g Mn(NO₃)₃.6H₂O(Alfa Aeser, 99.98%), 17.37 g of Ce(NO₃)₃.6H₂O (Sigma Aldrich, 99.99%), 137.21 g 3-aminopropylsilanetriol (Gelest, 25% water solution) and 1.3 kg urea (Sigma Aldrich, 98%) in 1000 ml of water.

A) About 10 ml of the solution prepared in Example 2 was combusted in an alumina boat at about 500° C. in a muffle furnace. The resulting powder was collected, ground and annealed at about 1500° C. for about 5 hours in a in a tube furnace under a 97% N₂ 3% H₂ atmosphere. Luminescent material comprising cerium and manganese co-doped Lu₂CaAl₄SiO₁₂ with a garnet structure was thus prepared as verified by comparing X-ray diffraction pattern of the obtained material with a diffraction pattern from a standard garnet (lutetium aluminum garnet, LuAG).

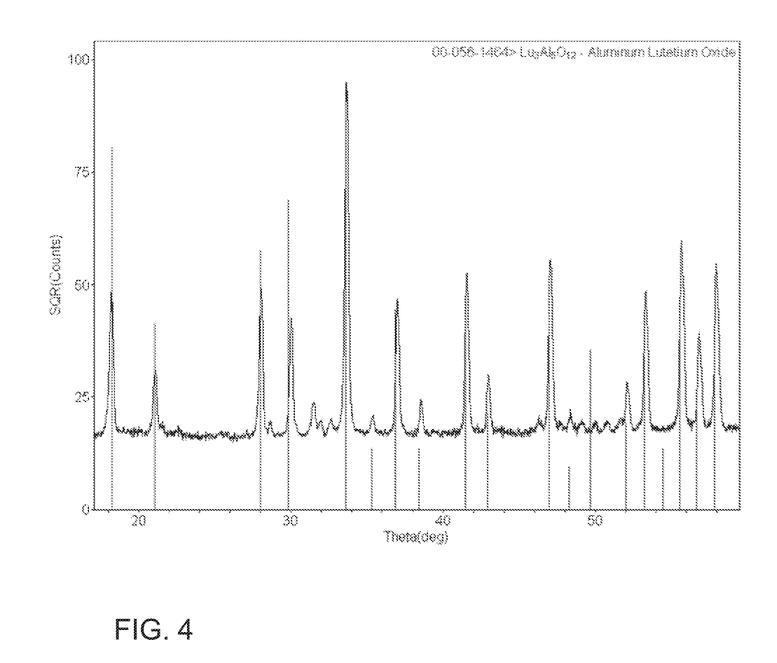

B) About 1000 ml of the solution prepared in Example 2 was delivered as atomized droplets into the hot reaction zone of a RF inductively coupled thermal plasma torch (Tekna Plasma, PL-35) operated at 20 kW plate power using 10 slm argon atomization gas. The plasma gas flow rates were as follows: central gas=20 slm argon, sheath gas=60 slm argon with 3 slm hydrogen. The solution underwent a combination of one-droplet-to-one-particle and vapor-to-particle conversion while passing through the plasma plume which can have maximum temperature regions over 10,000 K. The resulting particles were collected on porous ceramic filters. The particles were subsequently annealed at about 1500° C. for about 5 hours in a tube furnace under a 97% N₂ 3% H₂ atmosphere. Luminescent material comprising cerium and manganese co-doped Lu₂CaAl₄SiO₁₂ with a garnet structure was thus prepared. XRD analysis (shown in FIG. 4) confirmed that the prepared material is a garnet (JCPDS 00-056-1464, corresponding to standard lutetium aluminum garnet, LuAG) and structural considerations in accordance to ionic radii point to the formation of the material with the correct stoichiometry.

### Example 3

### Europium-Doped Ca₃Si₂O₇

Based on the stoichiometric ratios for a europium-doped Ca₃Si₂O₇, the following compounds were used: A solution was prepared using 435.25 g of Ca(NO₃)₃.4H₂O (Sigma Aldrich, 99%), 857.94 g PEG-POSS(Hybrid Plastics product PG1190), 7.91 g of Eu(NO₃)₃.5H₂O (Sigma Aldrich, 99.9%), 1.3 kg urea (Sigma Aldrich, 98%) in 1000 ml of water.

A) About 10 ml of the solution prepared in example 3 was combusted in an alumina boat at about 500° C. in a muffle furnace. The resulting powder was collected, ground and annealed at about 1350° C. for about 5 hours in a in a tube furnace under a 97% N₂ 3% H₂ atmosphere. Luminescent material comprising a mixture of europium doped Ca₃Si₂O₇ and Ca₂(SiO₄) was thus prepared.

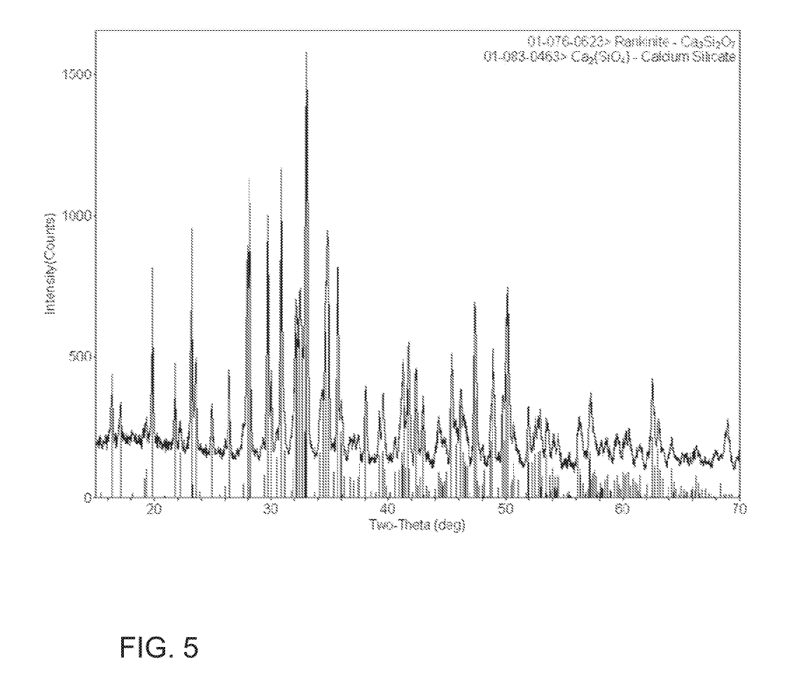

B) About 1000 ml of the solution prepared in Example 3 was delivered as atomized droplets into the hot reaction zone of a RF inductively coupled thermal plasma torch (Tekna Plasma, PL-35) operated at 20 kW plate power using 10 slm argon atomization gas. The plasma gas flow rates were as follows: central gas=20 slm argon, sheath gas=60 slm argon with 3 slm hydrogen. The solution underwent a combination of one-droplet-to-one-particle and vapor-to-particle conversion while passing through the plasma plume which can have maximum temperature regions over 10,000 K. The particles were subsequently annealed at about 1350° C. for about 5 hours in a tube furnace under a 97% N₂ 3% H₂ atmosphere. Luminescent material comprising a mixture of europium-doped Ca₃Si₂O₇ and Ca₂(SiO₄) was thus prepared. XRD analysis (comparing to JCPDS 01-076-0623 [Ca₃SiO₇] and 01-083-0463 [Ca₂(SiO₄)]) confirming the formation of the intended materials is shown in FIG. 5.

It will be appreciated by those skilled in the art that various omissions, additions and modifications may be made to the processes described above without departing from the scope of the invention, and all such modifications and changes are intended to fall within the scope of the invention.

1. A method for making an inorganic silicon material comprising:
providing soluble precursors comprising at least one silicon containing precursor, said precursors being soluble in water;
forming a precursor solution by dissolving the soluble precursors in a solvent, wherein the precursor solution has a pH of between about 5.0 and about 9.0; and
applying heat to the precursor solution until a solid inorganic multi-elemental silicon material forms without polymerization, wherein the solid inorganic multi-elemental silicon is substantially free of solvent as a result of the heating,
wherein the heat is applied to the precursor solution using a heat source having a temperature that is at least 250° C.

2. The method of claim 1, wherein the solvent is water.

3. The method of claim 1, wherein the precursor solution has a pH of between about 6.0 and about 8.0.

4. The method of claim 1, wherein the precursor solution is halide free.

5. The method of claim 1, wherein the precursor solution further comprises at least one expansive component and a carrier solvent.

6. The method of claim 1, further comprising providing an aerosol comprising a plurality of droplets of the precursor solution and a carrier gas prior to the step of applying heat.

7. The method of claim 6, wherein the heat is generated in a reaction zone where the aerosol is passed therethrough.

8. The method of claim 7, further comprising collecting the inorganic silicon material after the material has exited from the reaction zone.

9. The method of claim 1, wherein the heat is derived from a flowing heat source.

10. The method of claim 9, wherein the flowing heat source is selected from a thermal plasma, a flame spray, a hot-wall reactor, or a spray pyrolysis system.

11. The method of claim 1, wherein the heat is derived from a static heat source.

12. The method of claim 11, wherein the static heat source is selected from a box furnace or a muffle furnace.

13. The method of claim 1, wherein the silicon precursor is an organosilane.

14. The method of claim 13, wherein the organosilane is selected from 3-aminopropylsilane triol, 3-aminopropyltrimethoxysilane, 3-aminopropylethoxysilane, 3-aminopropylisopropoxysilane, tetramethylammonium silicate, water soluble-PUSS (Polyhedral Oligomeric Silsesquioxane) including PEG-PUSS and OctaAmmonium PUSS, carboxyethylsilanetriol sodium salt, sodium methylsiliconate, sodium metasilicate, 3-(trihydroxysilyl)-1-propanesulfonic acid, sodium 3-(trihydroxysilyl)-1-propanesulfonate, and sodium 3-trihydroxysilylpropylmethylphosphonate.

15. The method of claim 1, further comprising adding a stabilizing compound to the aqueous solution.

16. The method of claim 1, wherein the inorganic multi-elemental silicon material is a bi-elemental non-oxide silicon material wherein silicon is one of the two different atomic elements.

17. The method of claim 1, wherein the inorganic multi-elemental silicon material is a tri- or higher multi-elemental silicon material wherein silicon is one of the three or more atomic elements.

18. The method of claim 1, wherein the precursor solution comprises silicon, hydrogen, nitrogen, carbon and oxygen atoms.

19. The method of claim 1, wherein the soluble precursors do not include an alkali atom therein.

20. The method of claim 1, wherein the precursor solution has a pH of between about 6.5 and about 7.5.
